(19) United States
(12) Patent Application Publication
(10) Pub. No.: US 2024/0025357 A1
(43) Pub. Date: Jan. 25, 2024

(54) WIRE HARNESS AND WIRE HARNESS INTEGRATED MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Satoshi TAKAKI, Osaka (JP)

(21) Appl. No.: 18/031,140

(22) PCT Filed: Oct. 13, 2021
(86) PCT No.: PCT/JP2021/037815

§ 371 Date: Apr. 10, 2023

(30) Foreign Application Priority Data
Oct. 21, 2020 (JP) 2020-176902

(51) Int. Cl. B60R 16/02; H02G 3/32; H02G 3/04

(52) U.S. Cl. CPC B60R 16/0215; H02G 3/32; H02G 3/0406; H02G 3/0481

(57) ABSTRACT

An aspect of the present disclosure provides a wire harness and a wire harness integrated module that enable simplification of attachment work. A wire included in the wire harness according to an aspect of the present disclosure is attached and fixed to an attachment target via a plurality of fixing portions. The fixing portions fix the wire to the attachment target in a state of being arranged in such a manner that a second length that is a distance between adjacent fixing portions after the wire is attached to the attachment target is shorter than a first length that is a distance between the adjacent fixing portions before the wire is attached to the attachment target. A path regulating portion regulates a path of the wire in such a manner that the wire has a warped shape when attached to the attachment target.

### TECHNICAL FIELD

The present disclosure relates to a wire harness and a wire harness integrated module.

### BACKGROUND

Conventionally, various pieces of electrical equipment are mounted on a vehicle, and those pieces of electrical equipment are electrically connected using a wire harness. Such a wire harness is attached to a vehicle body via a plurality of clamp members, for example (see Patent Document 1, for example). A wire harness disclosed in Patent Document 1 is attached to a vehicle body in a bent state so as to conform to a bent shape of a wire harness wiring path. The bent wire harness maintains its shape due to its flexural rigidity.

### PRIOR ART DOCUMENT

### Patent Document

Patent Document 1: JP 2012-115023 A

### SUMMARY OF THE INVENTION

### Problem to be Solved

However, in the case where the wire harness is attached in the bent state to the vehicle body, attachment work has been troublesome because a worker needs to bend the wire harness by him or herself.

An object of the present invention is to provide a wire harness and a wire harness integrated module that can simplify attachment work.

### Means to Solve the Problem

A wire harness according to an aspect of the present disclosure includes: a plurality of fixing portions configured to fix a wire to an attachment target in a state of being arranged in such a manner that a second length that is a distance between adjacent fixing portions after the wire is attached to the attachment target is shorter than a first length that is a distance between the adjacent fixing portions before the wire is attached to the attachment target; and a path regulating portion configured to regulate a path of the wire in such a manner that the wire has a warped shape when attached to the attachment target.

A wire harness integrated module according to an aspect of the present disclosure includes: a wire routed on an inner lining provided on a body; a plurality of path regulating portions that are portions in the inner lining to which the wire is attached and regulate a path of the wire in such a manner that the wire has a warped shape when attached to the path regulating portions; and fixing portions for attaching and fixing the wire to the path regulating portions.

### Effect of the Invention

According to the present invention, wire attachment work can be simplified.

### BRIEF DESCRIPTION OF THE DRAWINGS

FIG. 1 is a schematic diagram showing an example of routing of a wire harness according to a first embodiment.

FIG. 2 is a perspective view of a fixing portion.

FIG. 3 is a cross-sectional view of the fixing portion.

FIGS. 4A to 4F are diagrams showing exemplary formation patterns of path regulating portions.

FIG. 5 is a schematic diagram of the wire harness to which fixing portions have been attached.

FIG. 6 is a schematic diagram of the wire harness attached to an attachment target.

FIG. 7 is a diagram showing an action of the wire harness when subjected to a load.

FIG. 8 is a diagram showing an action of the wire harness when the wire harness vibrates.

FIG. 9 is a schematic diagram of a door module according to a second embodiment.

FIG. 10 is a partial cross-sectional view of the door module.

FIG. 11 is a front view showing an exemplary method for fixing wires.

FIG. 12 is a front view showing an exemplary method for fixing wires.

FIG. 13 is an illustrative diagram showing an exemplary method for fixing wires.

FIG. 14 is a partial cross-sectional view showing an exemplary method for fixing wires.

FIG. 15 is an illustrative diagram showing an exemplary method for fixing wires.

FIG. 16 is an illustrative diagram showing an exemplary method for fixing wires.

FIG. 17 is an illustrative diagram showing an exemplary method for fixing wires.

FIG. 18 is an illustrative diagram showing an exemplary method for fixing wires.

FIGS. 19A and 19B are illustrative diagrams showing an exemplary method for fixing wires.

FIGS. 20A and 20B are illustrative diagrams showing an exemplary method for fixing wires.

### DETAILED DESCRIPTION TO EXECUTE THE INVENTION

First, embodiments of the present disclosure will be listed and described.

[1] A wire harness according to the present disclosure includes: a plurality of fixing portions configured to fix a wire to an attachment target in a state of being arranged in such a manner that a second length that is a distance between adjacent fixing portions after the wire is attached to the attachment target is shorter than a first length that is a distance between the adjacent fixing portions before the wire is attached to the attachment target; and a path regulating portion configured to regulate a path of the wire in such a manner that the wire has a warped shape when attached to the attachment target.

According to the configuration of this example, when the wire is attached to the attachment target with use of the plurality of fixing portions, the wire attached to the attachment target forms the warped shape by itself due to the distance between the adjacent fixing portions and the shape of the path regulating portion. Therefore, when a worker attaches the wire to the attachment target, the worker need not bend the wire manually by him or herself to make the wire have the warped shape. This simplifies attachment work.

[2] It is preferable that the warped shape is a shape that bulges in a direction away from the attachment target. According to this configuration, it is possible to keep the wire spaced apart from the attachment target when the wire is attached to the attachment target. Therefore, the wire can be kept from coming into contact with the attachment target, and consequently external damage on the wire can be suppressed, for example.

[3] It is preferable that the warped shape is an arcuate arch shape. According to this configuration, the warped shape is a well-balanced shape, and therefore, it is possible to efficiently suppress vibration applied to the wire.

[4] It is preferable that each of the fixing portions includes a holding portion that holds the wire and an engaging portion that is engaged with the attachment target. According to this configuration, the fixing portion can be formed in such a manner that the holding portion reliably holds the wire and the engaging portion engages with the attachment target.

[5] It is preferable that at least two path regulating portions are provided on opposite sides of a holding portion that holds the wire in each of the fixing portions. According to this configuration, it is possible to regulate the path of the wire on opposite sides of the fixing portion with use of the path regulating portions provided on the opposite sides of the fixing portion. Therefore, it is easy to set the wiring path of the wire to a desired pattern.

[6] It is preferable that each of the fixing portions and the path regulating portion are formed as one piece. This configuration eliminates the need to manage the fixing portion and the path regulating portion separately from each other, and therefore, it is easier to handle the components.

[7] It is preferable that the path regulating portion is formed separately from the fixing portions. This configuration increases the freedom in designing the components.

[8] A wire harness integrated module according to the present disclosure includes: a wire routed on an inner lining provided on a body; a plurality of path regulating portions that are portions in the inner lining to which the wire is attached and regulate a path of the wire in such a manner that the wire has a warped shape when attached to the path regulating portions; and fixing portions for attaching and fixing the wire to the path regulating portions.

According to the configuration of this example, when the wire is attached to the inner lining with use of the plurality of fixing portions, the wire attached to the inner lining forms the warped shape by itself due to a distance between adjacent path regulating portions and the shapes of the path regulating portions. Therefore, when a worker attaches the wire to the inner lining, the worker need not bend the wire manually by him or herself to make the wire have the warped shape. This simplifies attachment work.

[9] It is preferable that the path regulating portions are recessed portions provided in a portion of the inner lining. According to this configuration, the path regulating portions can be formed as simple recesses.

### Details of Embodiments of Present Disclosure

The following describes a wire harness and a door module that is a specific example of a wire harness integrated module according to the present disclosure with reference to the drawings. Note that the present invention is not limited to these examples, but is defined by the claims, and is intended to encompass all modifications within the meanings and scope that are equivalent to the claims. For the sake of convenience of description, some configurations may be exaggerated or simplified in the drawings. Also, dimensional ratios between components may differ from actual ones.

### First Embodiment

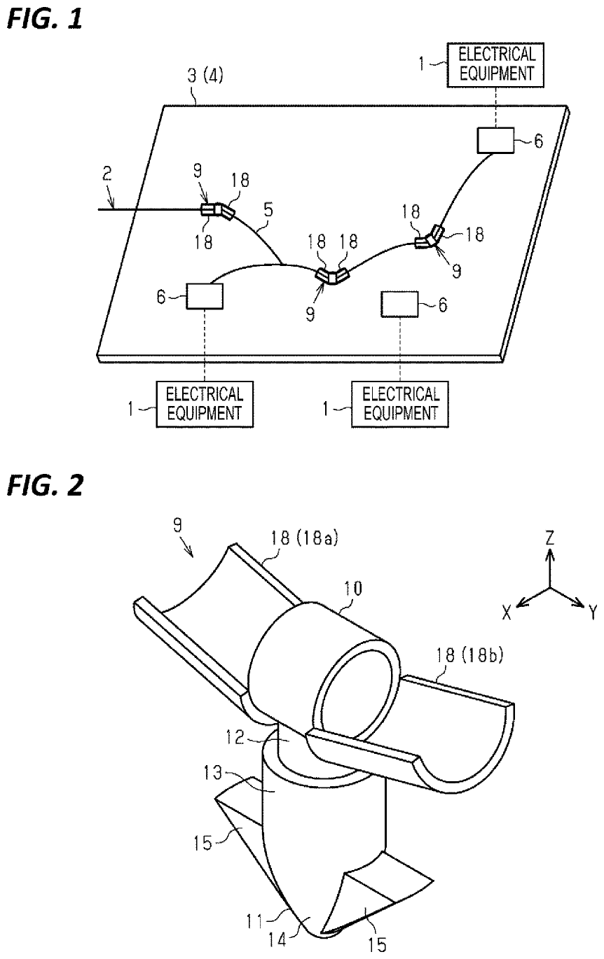

As shown in FIG. 1, a wire harness 2 that electrically connects electrical equipment 1 of a vehicle to a power source and an ECU (Electronic Control Unit) is attached and fixed to an attachment target 3 included in the vehicle. The attachment target 3 is a vehicle door 4, for example. The wire harness 2 includes one or more wires 5 that conduct electricity. The wires 5 branch off at an intermediate portion of the harness. The wires 5 are electrically connected to the electrical equipment 1 via connectors 6 provided on the attachment target 3. Examples of the electrical equipment 1 include a door lock device, various motors, and a speaker.

The wire harness 2 includes a plurality of fixing portions 9 for attaching and fixing each wire 5 to the attachment target 3. As described above, each wire 5 in this example is attached and fixed via the plurality of fixing portions 9 to the attachment target 3. The fixing portions 9 are preferably elastic bodies, for example. The elastic bodies are made of a rubber material, for example. Changes in the shape of the elastic fixing portions 9 are allowed to some extent when the fixing portions 9 are being attached to the attachment target 3, for example.

As shown in FIG. 2, each fixing portion 9 includes a holding portion 10 that holds the wire 5, an engaging portion 11 that is engaged with the attachment target 3 to which the wire 5 is attached, and a linkage portion 12 that links the holding portion 10 and the engaging portion 11. The holding portion 10 is a tubular portion, a clamp, or a zip tie, for example. The holding portion 10 holds one or more wires 5.

The engaging portion 11 includes a main body 13 and a protrusion 14 protruding from the main body 13. The protrusion 14 has a tapered shape such as a substantially cone shape. A plurality of (in this example, two) projections 15 are provided on a side surface of the protrusion 14. In the case where two projections 15 are provided, the two projections 15 are provided at positions opposite to each other in a radial direction of the protrusion 14.

The linkage portion 12 is formed so as to be smaller than the holding portion 10 and the engaging portion 11 in a plane direction of the fixing portion 9 (X-Z axes plane in FIG. 2). Also, the linkage portion 12 is formed so as to be smaller than the holding portion 10 and the engaging portion 11 in a height direction of the fixing portion 9 (Z axis direction in FIG. 2).

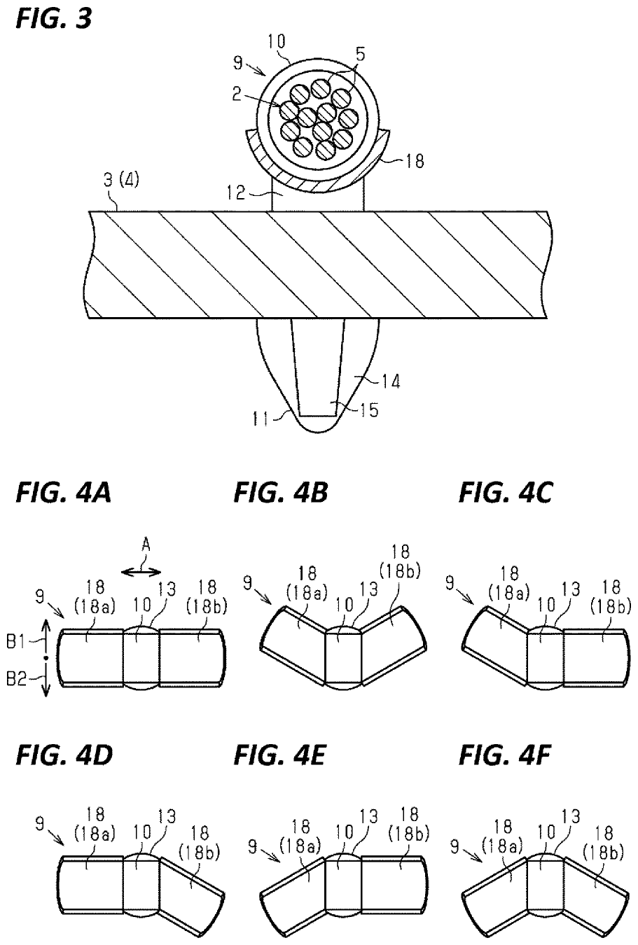

As shown in FIGS. 2 and 3, the wire harness 2 includes path regulating portions 18 that regulate a wiring path of the wire 5 attached via the fixing portions 9 to the attachment target 3 and direct the wire 5 to a specific direction. Each path regulating portion 18 is formed together with a fixing portion 9 as one piece, for example. The path regulating portions 18 regulate the path of the wire 5 in such a manner that the wire 5 has a warped shape when attached to the attachment target 3. For example, two path regulating portions 18 are provided on opposite sides of the holding portion 10 holding the wire 5 in each fixing portion 9. In this case, one of the path regulating portions 18 is referred to as a “first path regulating portion 18a”, and the other path regulating portion 18 is referred to as a “second path regulating portion 18b”.

FIGS. 4A to 4F show formation patterns of the path regulating portions 18. For example, there are six arrangement patterns of the first path regulating portion 18a and the second path regulating portion 18b as shown in FIGS. 4A to 4F. Note that the direction in which the wire 5 is inserted into the holding portion 10 will be referred to as an “insertion direction A”. Also, a direction that is orthogonal to the insertion direction A will be referred to as a “first direction B1”, and the opposite direction will be referred to as a “second direction B2”.

FIG. 4A shows an example in which both the first path regulating portion 18a and the second path regulating portion 18b extend along the insertion direction A. FIG. 4B shows an example in which both the first path regulating portion 18a and the second path regulating portion 18b are inclined toward the first direction B1. FIG. 4C shows an example in which the first path regulating portion 18a is inclined toward the first direction B1 and the second path regulating portion 18b extends along the insertion direction A. FIG. 4D shows an example in which the first path regulating portion 18a extends along the insertion direction A and the second path regulating portion 18b is inclined toward the second direction B2. FIG. 4E shows an example in which the first path regulating portion 18a is inclined toward the second direction B2 and the second path regulating portion 18b extends along the insertion direction A. FIG. 4F shows an example in which both the first path regulating portion 18a and the second path regulating portion 18b are inclined toward the second direction B2.

Fixing portions 9 to be used are selected as appropriate from the fixing portions 9 shown in FIGS. 4A to 4F in accordance with the wiring directions of the wire 5. Note that, in the example shown in FIG. 1, two fixing portions 9 formed as shown in FIG. 4B and a fixing portion 9 formed as shown in FIG. 4D are used to fix the wire 5 to the attachment target 3.

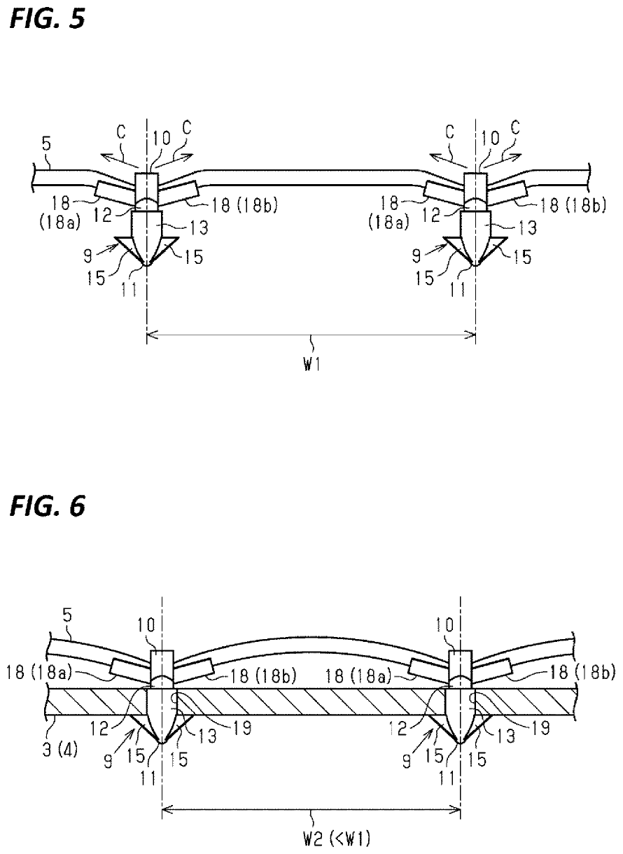

As shown in FIG. 5, when the wire 5 is passed through the holding portions 10 of the respective fixing portions 9, the wiring direction of the wire 5 is regulated by the path regulating portions 18. In the example shown in FIG. 5, the wire 5 is guided in directions (directions indicated by arrows C in FIG. 5) in which the path regulating portions 18 extend, and thus the path of the wire 5 is regulated.

As shown in FIGS. 5 and 6, the fixing portions 9 are arranged in such a manner that a second length W2 (see FIG. 6) that is a distance between adjacent fixing portions 9 after the wire 5 is attached to the attachment target 3 is shorter than a first length W1 (see FIG. 5) that is a distance between the adjacent fixing portions 9 before the wire 5 is attached to the attachment target 3. The first length W1 is set to a value that enables the wire 5 to have a warped shape (arch shape) with a desired height when attached and fixed to the attachment target 3 via the fixing portions 9. That is, arrangement intervals between the fixing portions 9 are set as appropriate according to the height of the desired warped shape of the wire 5.

As shown in FIG. 6, when the wire 5 is attached to holes 19 in the attachment target 3 with use of the fixing portions 9, the wire 5 has a warped shape with its route guided by the path regulating portions 18. The warped shape is a shape that bulges in a direction away from the attachment target 3. In this example, the warped shape is an arcuate arch shape. The wire 5 forms the warped shape (arch shape) by itself when the fixing portions 9 are fitted into the attachment target 3 to attach the wire 5 to the holes 19 in the attachment target 3 using the fixing portions 9.

Next, actions of the wire harness 2 according to the present embodiment will be described.

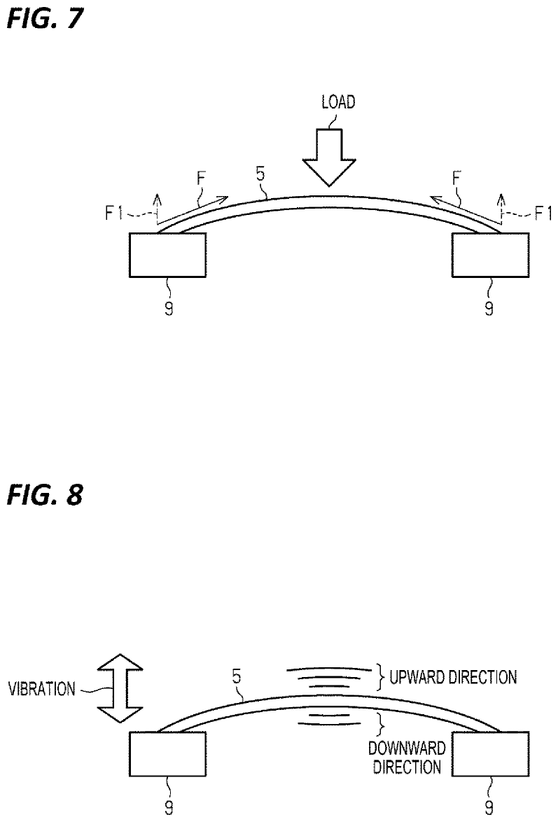

The following describes an example in which a load is applied to the wire 5 from above as shown in FIG. 7, for example. In this example, the wire 5 is attached and fixed to the attachment target 3 in such a manner as to have the warped shape, and accordingly is fixed to the attachment target 3 in a state where flexural rigidity is applied. That is, the wire 5 is attached to the attachment target 3 in such a manner as to maintain its shape due to its flexural rigidity. Therefore, even when a load is applied to the wire 5 from above, vibrations are suppressed by an upward component F1 of a flexural rigidity force F. Thus, vibrations of the wire 5 can be suppressed.

FIG. 8 shows an example in which vibration is applied to the wire 5. In this case, the wire 5 has the warped shape, and accordingly, the wire 5 exhibits flexural rigidity and is unlikely to deform. Therefore, even when vibration is applied to the wire 5, deformation of the wire 5 in the upward direction and the downward direction is unlikely to occur due to the flexural rigidity of the wire 5 having the warped shape. Also, when the wire 5 vibrates, a reaction force is applied from the fixing portions 9, and therefore, downward vibrations can be suppressed.

The following effects can be obtained with the wire harness 2 according to the embodiment described above.

(1) The plurality of fixing portions 9 of the wire harness 2 fix the wire 5 to the attachment target 3 in a state of being arranged in such a manner that the second length W2 that is a distance between adjacent fixing portions 9 after the wire 5 is attached to the attachment target 3 is shorter than the first length W1 that is a distance between the adjacent fixing portions 9 before the wire 5 is attached to the attachment target 3. The path regulating portions 18 of the wire harness 2 regulate the path of the wire 5 in such a manner that the wire 5 has the warped shape when attached to the attachment target 3.

According to the configuration of this example, when the wire 5 is attached and fixed to the attachment target 3 with use of the plurality of fixing portions 9, the wire 5 attached to the attachment target 3 forms the warped shape by itself due to the distance between adjacent fixing portions 9 and the shapes of the path regulating portions 18. Therefore, when a worker attaches the wire 5 to the attachment target 3, the worker need not bend the wire 5 manually by him or herself to make the wire 5 have the warped shape. This simplifies attachment work.

(2) The warped shape is a shape that bulges in a direction away from the attachment target 3. According to this configuration, it is possible to keep the wire 5 spaced apart from the attachment target 3 when the wire 5 is attached to the attachment target 3. Therefore, the wire 5 can be kept from coming into contact with the attachment target 3, and consequently external damage and bending of the wire 5 can be suppressed, for example.

(3) In the case where the wire 5 is unlikely to come into contact with the attachment target 3, risks of external damage and bending are reduced, and accordingly, it is possible to use a wire harness 2 that does not include an outer covering member. This leads to a reduction in the cost of the wire 5 and a consequent reduction in the cost of components of the wire harness 2.

(4) The wire harness 2 is highly resistant to vibration, and therefore, it is possible to reduce the number of fixing portions 9. Also, a reduction in the number of fixing portions 9 leads to a reduction in labor required to attach the fixing portions 9, which contributes to further simplification of the attachment work.

(5) In the case where the warped shape of the wire 5 is a shape that bulges in the direction away from the attachment target 3, the wire 5 can be positioned close to the attachment target 3. Therefore, it is possible to reduce the height from the attachment target 3 to the wire 5.

(6) The warped shape is an arcuate arch shape. According to this configuration, the warped shape is a well-balanced shape, and therefore, it is possible to efficiently suppress vibration applied to the wire 5.

(7) Each fixing portion 9 includes the holding portion 10 that holds the wire 5 and the engaging portion 11 that is engaged with the attachment target 3. According to this configuration, the fixing portion 9 can be formed in such a manner that the holding portion 10 reliably holds the wire 5 and the engaging portion 11 firmly engages with the attachment target 3.

(8) Each fixing portion 9 is provided with at least two path regulating portions 18 that are provided on opposite sides of the holding portion 10 holding the wire 5. According to this configuration, it is possible to regulate the path of the wire 5 on opposite sides of the fixing portion 9 with use of the path regulating portions 18 provided on the opposite sides of the fixing portion 9. Therefore, it is easy to set the wiring path of the wire 5 to a desired pattern.

(9) The path regulating portions 18 and the fixing portion 9 are formed as one piece. This configuration eliminates the need to manage the fixing portion 9 and the path regulating portions 18 separately from each other, and therefore, it is easier to handle the components.

### Second Embodiment

Next, a second embodiment will be described. Note that the second embodiment is an embodiment in which the method for fixing wires 5 described in the first embodiment is changed. Therefore, portions that are the same as those in the first embodiment are denoted by the same reference signs as those used in the first embodiment, and detailed descriptions thereof are omitted. The following describes only differences from the first embodiment in detail.

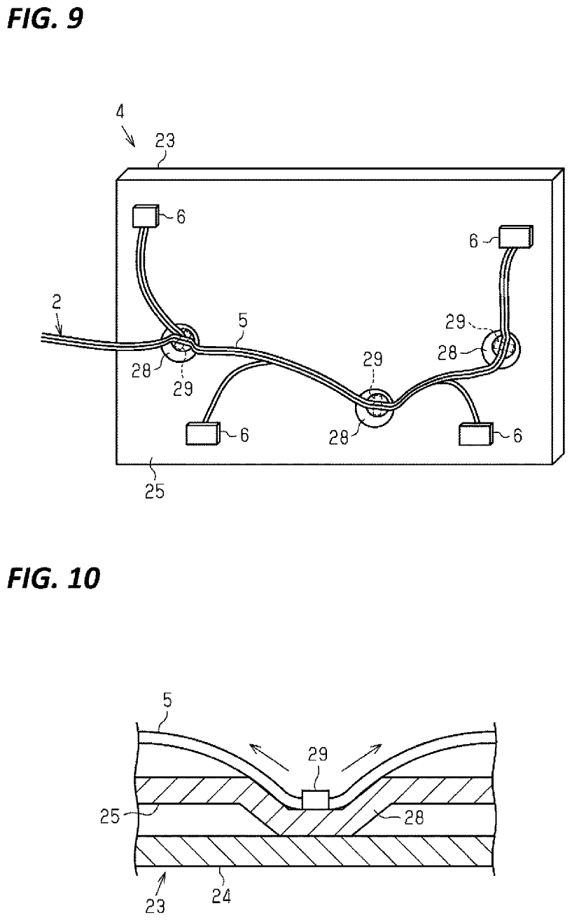

As shown in FIGS. 9 and 10, a vehicle door 4 includes a door module 23 that includes a wire harness 2. As shown in FIG. 10, the door module 23 includes a door body 24 that is the main body of the vehicle door 4 and one or more door inner trims 25 that are interior equipment of the vehicle door 4. Each door inner trim 25 is attached and fixed to an inner wall surface of the door body 24. Note that the door module 23 corresponds to a wire harness integrated module, the door body 24 corresponds to a body, and the door inner trim 25 corresponds to an inner lining.

The door module 23 includes a wire 5 that is routed on the door inner trim 25 provided on the door body 24, a plurality of path regulating portions 28 that regulate a path of the wire 5, and fixing portions 29 for attaching and fixing the wire 5 to the path regulating portions 28. The path regulating portions 28 are provided as portions to which the wire 5 is to be attached, and regulate the path of the wire 5 in such a manner that the wire 5 has a warped shape when attached to the path regulating portions 28. In this example, the path regulating portions 28 are recessed portions provided in a portion of the door inner trim 25, for example.

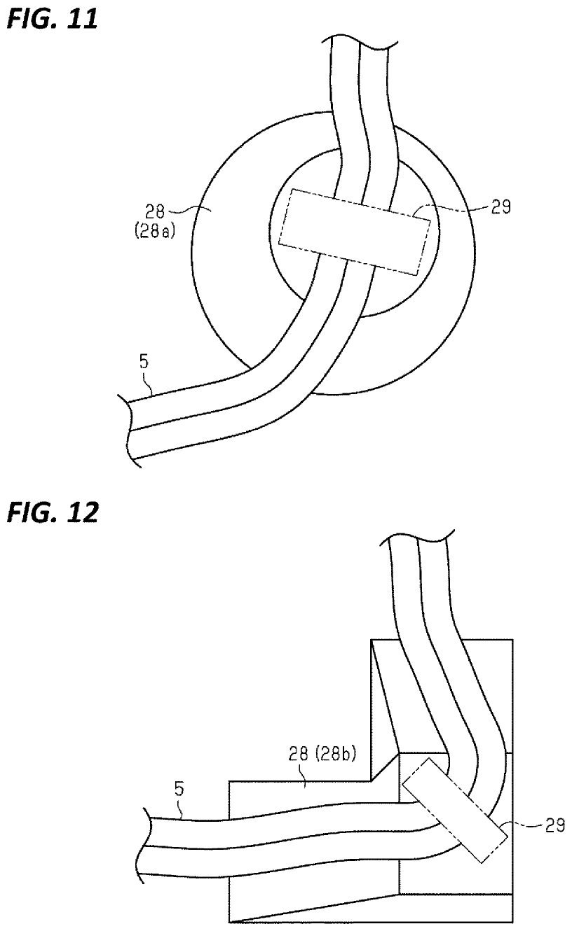

FIGS. 11 and 12 show specific shapes of the path regulating portions 28. As shown in FIG. 11, an example of the path regulating portions 28 is a round-hole-shaped recessed portion 28a formed in the door inner trim 25. As shown in FIG. 12, another example of the path regulating portions 28 is a polygonal-hole-shaped recessed portion 28b formed in the door inner trim 25. The following describes the case where the path regulating portions 28 are round-hole-shaped recessed portions 28a.

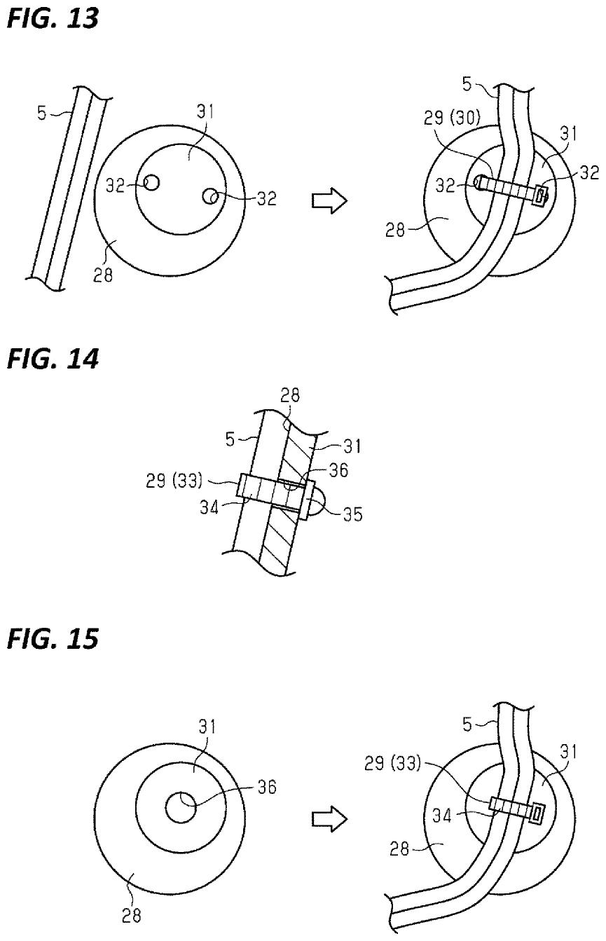

FIGS. 13 to 18, 19A, 19B, 20A, and 20B show specific examples of the method for fixing wires 5 to the path regulating portions 28 (and specific examples of the fixing portions 29). FIG. 13 shows an exemplary fixing method in which a zip tie 30 is used as the fixing portion 29. In this case, two holes 32 for passing the zip tie 30 are formed in a bottom wall 31 of each path regulating portion 28. When the wires 5 are to be attached to the door inner trim 25, first, the wires 5 are positioned on the path regulating portion 28. Then, the zip tie 30 is passed through one of the holes 32 from the front side, drawn from the rear side through the other hole 32, and is then tightened. Thus, the wires 5 are fixed to the path regulating portion 28.

FIGS. 14 and 15 show an exemplary fixing method in which a clip 33 is used as the fixing portion 29. The clip 33 is a band clip, for example. The clip 33 includes a band 34 for bundling the wires 5 and a protrusion 35 that is engaged with the path regulating portion 28. The bottom wall 31 of the path regulating portion 28 has a hole 36 with which the protrusion 35 is engaged. As shown in FIG. 15, when the wires 5 are to be attached to the door inner trim 25, the wires 5 are fixed to the band 34, and the protrusion 35 is inserted into the hole 36, and thus the wires 5 are fixed to the path regulating portion 28.

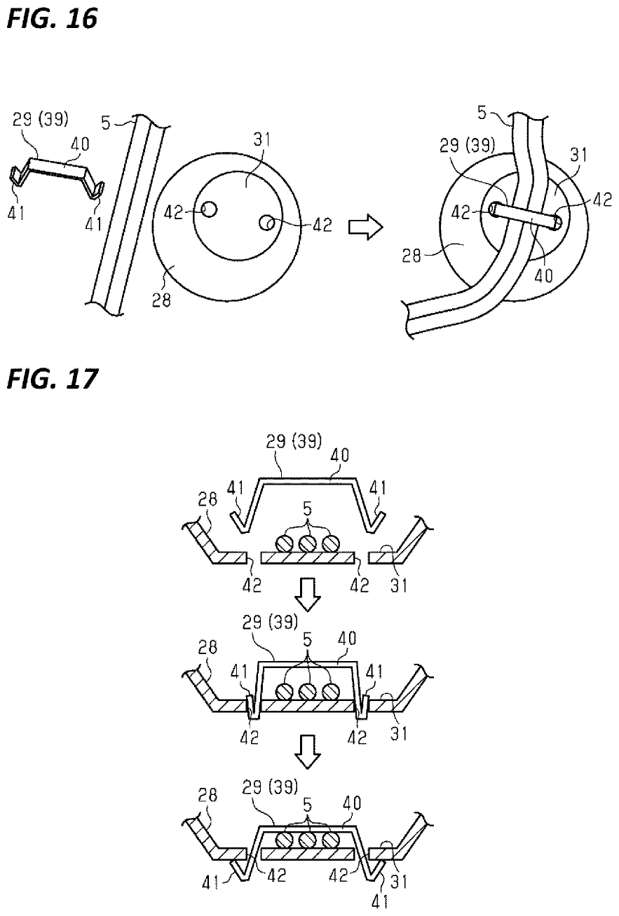

FIGS. 16 and 17 show an exemplary fixing method in which a holding plate 39 is used as the fixing portion 29. The holding plate 39 includes a main body 40 and spring portions 41 formed at two ends of the main body 40. Also, holes 42 for inserting the spring portions 41 of the holding plate 39 are formed in the bottom wall 31 of the path regulating portion 28. As shown in FIG. 17, when the wires 5 are to be attached to the door inner trim 25, the holding plate 39 is fixed to the holes 42 by inserting the spring portions 41 of the holding plate 39 into the holes 42 in a state where the wires 5 are arranged and positioned on the bottom wall 31 of the path regulating portion 28. Thus, the wires 5 are fixed to the path regulating portion 28.

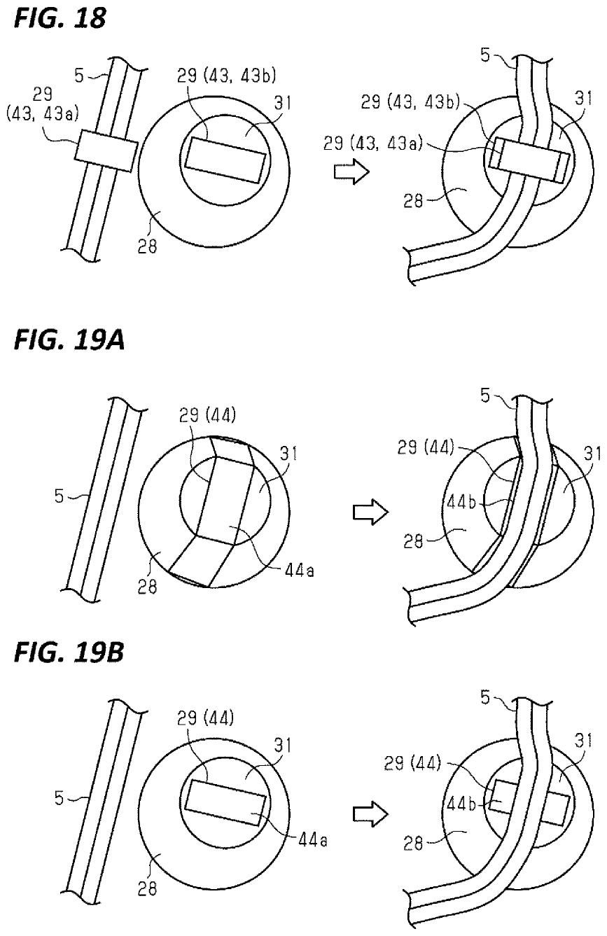

FIG. 18 shows an exemplary fixing method in which pieces 43 of MAGIC TAPE (registered trademark) are used as the fixing portion 29. The pieces 43 of MAGIC TAPE include a first piece 43a that is attached to the wires 5 and a second piece 43b that is attached to at least the bottom wall 31 of the path regulating portion 28. When the wires 5 are to be attached to the door inner trim 25, the first piece 43a and the second piece 43b are attached to each other to fix the wires 5 to the path regulating portion 28.

FIGS. 19A and 19B show an example in which a double-sided tape 44 is used as the fixing portion 29. FIG. 19A shows an example in which the double-sided tape 44 is arranged so as to extend in a lengthwise direction. FIG. 19B shows an example in which the double-sided tape 44 is arranged so as to extend in a transverse direction. When the wires 5 are to be attached to the door inner trim 25, the double-sided tape 44 is attached to at least the bottom wall 31 of the path regulating portion 28, a release paper 44a on the front surface of the double-sided tape 44 is removed to expose an adhesive surface 44b, and the wires 5 are attached to the adhesive surface 44b. Thus, the wires 5 are fixed to the path regulating portion 28.

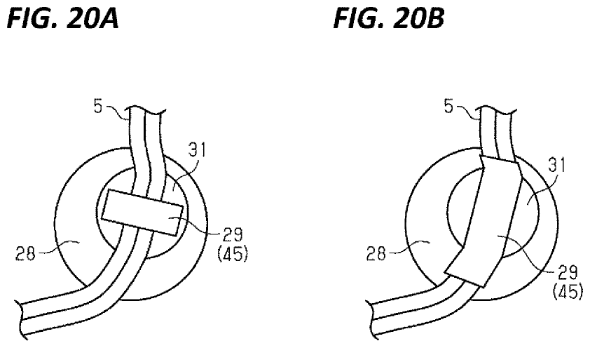

FIGS. 20A and 20B show an example in which ordinary tape 45 is used as the fixing portion 29. FIG. 20A shows an example in which the tape 45 is attached in the transverse direction. FIG. 20B shows an example in which the tape 45 is attached in the lengthwise direction. When the wires 5 are to be attached to the door inner trim 25, the wires 5 are positioned on the bottom wall 31 of the path regulating portion 28, and the tape 45 is attached to the wires 5 from above. Thus, the wires 5 are fixed to the path regulating portion 28.

In the above examples, the recessed path regulating portions 28 are provided in the door inner trim 25, and are used as portions to which the wires 5 are to be attached. Therefore, the door inner trim 25 can be effectively used as a place to which the wires 5 are to be attached. Also, the wires 5 can be attached to the door inner trim 25 with use of a general-purpose component such as a tape, and this contributes to a reduction in the cost of components.

The following effects can be obtained with the door module 23 according to the embodiment described above.

(10) The door module 23 includes a wire 5, the path regulating portions 28, and the fixing portions 29. The wire 5 is routed on the door inner trim 25 provided on the door body 24. The path regulating portions 28 are provided as portions in the door inner trim 25 to which the wire 5 is attached, and regulate the path of the wire 5 in such a manner that the wire 5 has a warped shape when attached to the path regulating portions 28. The fixing portions 29 are used to attach and fix the wire 5 to the path regulating portions 28.

According to the configuration of this example, when the wire 5 is attached to the door inner trim 25 with use of the plurality of fixing portions 29, the wire 5 attached to the door inner trim 25 forms the warped shape by itself due to the distance between adjacent path regulating portions 28 and the shapes of the path regulating portions 28. Therefore, when a worker attaches the wire 5 to the door inner trim 25, the worker need not bend the wire 5 manually by him or herself to make the wire 5 have the warped shape. This simplifies attachment work.

(11) The path regulating portions 28 are recessed portions provided in a portion of the door inner trim 25. According to this configuration, the path regulating portions 28 can be formed as simple recesses.

Note that the embodiments of the present disclosure can be modified as described below. The embodiments and the following modifications can be combined so long as no technical contradiction arises.

In the first embodiment, the path regulating portions 18 may be formed separately from the fixing portion 9. This configuration increases the freedom in designing the components.

In the case where the path regulating portions 18 are formed separately from the fixing portion 9 in the first embodiment, the path regulating portions 18 may be spaced apart from the fixing portion 9.

In the first embodiment, the fixing portion 9 is not limited to an elastic body, and is only required to be made of resin.

In the first embodiment, a configuration is also possible in which only the engaging portion 11 is an elastic body in the fixing portion 9, for example.

In the first embodiment, the attachment target 3 is not limited to the vehicle door 4, and is only required to be a member that constitutes the vehicle body.

In the first embodiment, the attachment target 3 is preferably a steel plate, for example.

In the first embodiment, the holding portion 10 is only required to be formed in such a manner as to be capable of holding the wires 5.

In the first embodiment, the path regulating portions 18 provided on opposite sides may have different shapes from each other.

In the first embodiment, a configuration is also possible in which the path regulating portion 18 is provided only on one side of the holding portion 10.

In the first embodiment, a configuration is also possible in which a plurality of path regulating portions 18 are provided on each side of the holding portion 10, for example.

In the second embodiment, the various disclosed methods for fixing the wires 5 may be combined as appropriate.

In the second embodiment, the door inner trim 25 to which the wires 5 are attached may be constituted by a plurality of members.

In each embodiment, the warped shape is not limited to the arch shape, and may also be other shapes such as a bent shape.

In each embodiment, the outer surface of the wire 5 may be covered with an outer covering member.

In each embodiment, the wires 5 may be fixed using a combination of the structures described in the first and second embodiments.

In each embodiment, the wire harness integrated module may be applied not only to a door, but also to a floor, a seat, or the like.

In each embodiment, the method for fixing the wires 5 may be applied not only to a vehicle, but also to various types of equipment and devices.

As shown in FIGS. 2 and 3, each path regulating portion 18 may have a half-cylindrical shape of the lower half of a cylinder.

Each of the attachment target 3 and the inner lining 25 in the embodiments may be referred to as an attachment surface for attaching the wire 5. Each of the holes 19 and the path regulating portions 28 in the embodiments may be referred to as a fixing position on the attachment surface. Each of the fixing portions 9 in the embodiment may be referred to as a wire clamp. Each of the holding portion 10 of the fixing portion 9, the path regulating portions 18a and 18b, and the path regulating portions 28 in the embodiments may be referred to as a wire receiving surface configured to receive the wire 5 and gently curve the wire 5. The difference between the first length W1 and the second length W2 in the embodiments may be referred to as an excess length.

When the wire 5 is routed on the attachment target 3 or the inner lining 25 in the embodiments, a first point and a second point in the length direction of the wire 5 may be fixedly positioned at two fixing positions on the attachment target 3 or the inner lining 25, and a lengthwise intermediate portion of the wire 5 between the first point and the second point may be configured to bridge the two fixing positions on the attachment target 3 or the inner lining 25 in a state of having an excess length. As shown in FIG. 6, when the first point and the second point in the length direction of the wire 5 are positioned at two holes 19, the wire 5 may extend between the two holes 19 in a state of floating without sagging.

[Supplementary Note 1]

As shown in FIGS. 5 and 6, in some aspects of the present disclosure, a wire harness (2) may include a wire (5), a plurality of fixing portions (9), and a path regulating portion (18) configured to attach the wire (5) to an attachment target (3), the plurality of fixing portions (9) may be arranged relative to the wire (5) in such a manner that a second length (W2) that is a distance between adjacent fixing portions (9) after the wire (5) is attached to the attachment target (3) is shorter than a first length (W1) that is a distance between the adjacent fixing portions (9) before the wire (5) is attached to the attachment target (3), and the path regulating portion (18) may be configured to regulate a path of the wire (5) in such a manner that the wire (5) has a warped shape when attached to the attachment target (3).

[Supplementary Note 2]

As shown in FIGS. 2, 5, and 6, in some aspects of the present disclosure, the path regulating portion (18) may be inclined away from the attachment target (3) in a direction away from the fixing portions (9) so that the wire (5) warps away from the attachment target (3) when attached to the attachment target (3) with use of the fixing portions (9).

[Supplementary Note 3]

As shown in FIGS. 9 and 10, in some aspects of the present disclosure, a wire harness integrated module (23) may include:
a wire (5) routed on an inner lining (25) provided on a body (24);
a plurality of path regulating portions (28) that are portions in the inner lining (25) to which the wire (5) is attached and that regulate a path of the wire (5) in such a manner that the wire (5) has a warped shape when attached to the path regulating portions (28); and
fixing portions (29) for attaching and fixing the wire (5) to the path regulating portions (28).

[Supplementary Note 4]

As shown in FIGS. 9 and 10, in some aspects of the present disclosure, the path regulating portions (28) may be recessed portions provided in a portion of the inner lining (25), and
the recessed portions may have inclined surfaces that come into contact with the wire (5) and regulate the path of the wire (5) in such a manner that the wire (5) has the warped shape.

Although examples of the present disclosure are described in each embodiment, it should be construed that the present disclosure is not limited to those examples and structures. The present disclosure encompasses various variations and modifications within the scope of equivalency. Also, various combinations, forms, and other combinations and forms that include one or more additional elements or from which one or more elements are omitted are also included in the scope and the idea of the present disclosure.

### LIST OF REFERENCE NUMERALS

1 Electrical equipment
2 Wire harness
3 Attachment target
5 Wire
9 Fixing portion
10 Holding portion
11 Engaging portion
18 Path regulating portion
23 Door module (wire harness integrated module)
24 Door body (body)
25 Door inner trim (inner lining)
28 Path regulating portion
29 Fixing portion
W1 First length
W2 Second length

1. A wire harness comprising:
a plurality of fixing portions configured to fix a wire to an attachment target in a state of being arranged in such a manner that a second length that is a distance between adjacent fixing portions after the wire is attached to the attachment target is shorter than a first length that is a distance between the adjacent fixing portions before the wire is attached to the attachment target; and
a path regulating portion configured to regulate a path of the wire in such a manner that the wire has a warped shape when attached to the attachment target.

2. The wire harness according to claim 1,
wherein the warped shape is a shape that bulges in a direction away from the attachment target.

3. The wire harness according to claim 1,
wherein the warped shape is an arcuate arch shape.

4. The wire harness according to claim 1,
wherein each of the fixing portions includes a holding portion that holds the wire and an engaging portion that is engaged with the attachment target.

5. The wire harness according to claim 1,
wherein at least two path regulating portions are provided on opposite sides of a holding portion that holds the wire in each of the fixing portions.

6. The wire harness according to claim 1,
wherein each of the fixing portions and the path regulating portion are formed as one piece.

7. The wire harness according to claim 1,
wherein the path regulating portion is formed separately from the fixing portions.

8. A wire harness integrated module comprising:
a wire routed on an inner lining provided on a body;
a plurality of path regulating portions that are portions in the inner lining to which the wire is attached and that regulate a path of the wire in such a manner that the wire has a warped shape when attached to the path regulating portions; and
fixing portions for attaching and fixing the wire to the path regulating portions.

9. The wire harness integrated module according to claim 8,
wherein the path regulating portions are recessed portions provided in a portion of the inner lining.

10. A wire routing structure comprising:
a wire; and
an attachment surface for attaching the wire,
wherein the wire includes, in a length direction thereof, a first point, a second point that is different from the first point, and a lengthwise intermediate portion between the first point and the second point,
the attachment surface includes a first fixing position and a second fixing position for fixedly positioning the first point and the second point in the length direction of the wire, respectively, and
when the first point and the second point in the length direction of the wire are fixedly positioned at the first fixing position and the second fixing position on the attachment surface, respectively, the lengthwise intermediate portion of the wire bridges the first fixing position and the second fixing position on the attachment surface in a state of floating and having an excess length.

11. The wire routing structure according to claim 10,
wherein, when the first point and the second point in the length direction of the wire are fixedly positioned at the first fixing position and the second fixing position on the attachment surface, respectively, the lengthwise intermediate portion of the wire extends between the first fixing position and the second fixing position on the attachment surface in a state of floating without sagging.

12. The wire routing structure according to claim 10,
wherein, when the first point and the second point in the length direction of the wire are fixedly positioned at the first fixing position and the second fixing position on the attachment surface, respectively, the lengthwise intermediate portion of the wire forms an arch that bridges the first fixing position and the second fixing position on the attachment surface.

13. The wire routing structure according to claim 10,
wherein the attachment surface includes a non-fixing position between the first fixing position and the second fixing position, and
the lengthwise intermediate portion of the wire does not come into contact with the non-fixing position on the attachment surface, and a gap is formed between the lengthwise intermediate portion and the non-fixing position.

14. The wire routing structure according to claim 10, further comprising:
a first wire clamp and a second wire clamp that are configured to come into direct contact with the first point and the second point in the length direction of the wire, respectively, and to be attached to the first fixing position and the second fixing position on the attachment surface, respectively,
wherein the first wire clamp includes a first wire receiving surface configured to receive the first point in the length direction of the wire and bend the wire into a U-shape or an obtuse-angled V-shape at the first point in the length direction, and
the second wire clamp includes a second wire receiving surface configured to receive the second point in the length direction of the wire and bend the wire into a U-shape or an obtuse-angled V-shape at the second point in the length direction.

15. The wire routing structure according to claim 10,
wherein the attachment surface is a panel including a first recessed portion and a second recessed portion,
the panel includes: a bottom of the first recessed portion and a bottom of the second recessed portion that correspond to the first fixing position and the second fixing position on the attachment surface; and a non-recessed surface extending between the first recessed portion and the second recessed portion,
the first recessed portion and the second recessed portion include wire receiving surfaces that receive the first point and the second point in the length direction of the wire, respectively, and
the wire receiving surface of the first recessed portion and the wire receiving surface of the second recessed portion are configured to bend the wire into a U-shape or an obtuse-angled V-shape at the first point and the second point in the length direction of the wire.

16. The wire routing structure according to claim 15, further comprising:
zip ties that come into direct contact with the first point and the second point in the length direction of the wire and fix the first point and the second point to the first recessed portion and the second recessed portion, respectively.
